(19) United States
(12) Patent Application Publication
(10) Pub. No.: US 2012/0059585 A1
(43) Pub. Date: Mar. 8, 2012

(54) Method and Apparatus for Offshore Hydrocarbon Electromagnetic Prospecting Based on Total Magnetic Field Measurements

(76) Inventors: Jostein Kåre Kjerstad, Stavanger (NO); Eduard B. Fainberg, Amersfoort (NL); Pavel Barsukov, Moscow (RU)

(21) Appl. No.: 13/257,567

(22) PCT Filed: Mar. 17, 2010
(86) PCT No.: PCT/NO2010/000102

§ 371 Date: Nov. 1, 2011

(30) Foreign Application Priority Data
Mar. 20, 2009 (NO) 20091179
Mar. 12, 2010 (NO) 201000353

(51) Int. Cl. G01V 3/38; G06F 19/00; G01V 3/12

(52) U.S. Cl. 702/6; 324/334

(57) ABSTRACT

A system for offshore hydrocarbon electromagnetic prospecting is described. The system includes a transmitter generating electromagnetic energy and injecting an electrical current into a flooded vertical cable. Electromagnetic fields generated by this current in the medium are measured by total field magnetometers or gradiometers. The measured response, which is sensitive to the resistivity of targets, is used to search for and identify hydrocarbon reservoirs. A method for offshore hydrocarbon electromagnetic prospecting is described as well.

A system for offshore hydrocarbon electromagnetic prospecting is described. The system includes a transmitter which generates electromagnetic energy and injects an electrical current into a vertical, flooded cable. An electromagnetic field generated by this current in the existing medium is measured by magnetometers or gradiometers. The main component of the system is a total-field magnetometer or gradiometer measuring, on the sea floor, a substratum response induced by sharp-termination pulses of an electrical current injected into a vertical cable submerged in sea water and hanging down from a vessel. The measured response, which is sensitive to the resistivity of underground structures, is used to search for and identify hydrocarbon reservoirs.

An analysis of Controlled Source Electromagnetic (CSEM) methods currently used for hydrocarbon prospecting (see the list of patents and publications that follows) shows that these methods may be divided into two groups.

The first group of methods, that is to say SBL, MTEM, CSEMI and others, see for example U.S. Pat. Nos. 4,617,518 and 6,522,146 of Srnka; U.S. Pat. No. 5,563,513 of Tasci; U.S. Pat. Nos. 0,027,130, 0,052,685, 0,048,105, 6,859,038, 6,864,684 and 6,628,119 of Eidesmo et al., US 2006132137 of MacGregor et al., EP 1425612 of Wright et al., WO03/048812 of MacGregor and Sinha, WO2004049008, GB2395563 and AU20032855 of MacGregor et al., are, based on the application of a horizontal transmitting current exciting both modes of the electromagnetic field—inductive and galvanic—in the ground; horizontal electric or magnetic sensors register both these modes. The EM response is registered by electric or magnetic sensors placed on the seabed—see U.S. Pat. No. 6,842,006 of Conti et al. The inductive mode of this configuration is more intensive than the galvanic one; at the same time, the main information on the resistive hydrocarbon reservoirs is contained in the galvanic mode. This principle feature essentially limits the depth of investigation and the resolution of the methods belonging to the first group. In addition, these methods require orientation of the electric and magnetic sensors, which complicates measurements, increases the electromagnetic noise and decreases the efficiency of the methods.

The second group of methods (MOSES, TEMP-OEL) (Edwards et al. 1981, 1985, 1986; Barsukov et al. 2007) are based on vertical transmitting and/or receiving currents and use measurements of only the galvanic mode of EM fields. Methods of this group provide maximal resolution and depth of investigation; however, they are even more sensitive to the orientation of sensors than the methods of the first group. Inaccuracy in sensors' orientation (tilt) can lead to erroneous results, so that these methods require special measures which complicate the surveying apparatus.

The difficulties that arise when components of an EM field are measured by the use of existing methods are described by MacGregor et al. (U.S. Pat. No. 0,309,346 A1 December, 2008).

To come to grips with these difficulties, MacGregor et al. (U.S. Pat. No. 0,309,346 A1 December 2008) have patented a particular detector for measuring “slanting” components of an EM field with subsequent recalculation into horizontal and vertical components to separate the inductive and galvanic modes. But this method may cause considerable errors because the galvanic mode is many times smaller than the inductive mode and is determined as a result of the subtraction of two large components containing both the inductive and the galvanic modes.

In addition, the electrodes used in the majority of CSEM methods for measuring the electric field have some drift and noise and bring additional noise into marine EM measurements, especially in conditions of shallow water. The present invention avoids this problem and provides the same resolution and depth of hydrocarbon exploration as the currently top TEMP-OEL methods.

The proposed method according to the invention operates with total magnetic field measurements by means of total-field magnetometers which are weakly dependent on tilts and, at the same time, keep the advantages of the most advanced TEMP-OEL methods. Magnetometers or gradiometers with optical pumping may be used for this purpose.

These characteristics of the method are achieved by using total-field magnetometers or total-field gradiometers when measuring the response of the medium in the form of the galvanic mode of the electromagnetic field generated by a current impressed on a vertical transmitter cable. Such measurements are possible by a particular installation of the transmitter (line) and receiver (magnetometer/gradiometer).

As it is well known, a total-field magnetometer measures the modulus of the magnetic field's projection onto the direction of the total geomagnetic field vector \vec{T}.

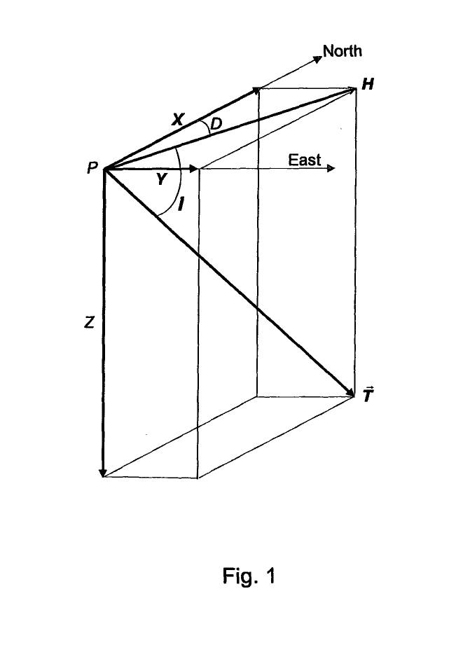

The elements describing geomagnetic field intensity are shown in FIG. 1: total intensity (T), horizontal component (H), vertical component (Z), and the north (X) and east (Y) components of the horizontal intensity. The elements describing the direction of the field are declination (D) and inclination (I).

Principal equations relating to the values of the elements are as follows:

T=(X²+Y²+Z²)^{1/2}=(H²+Z²)^{1/2} (1)

in which H=T cos(I), Z=T sin (I), X=H cos(D), Y=H sin(D)

The vertical current proposed in this invention to be used as the control source of the electromagnetic field excites only the galvanic mode of electromagnetic fields in a laterally uniform section. This mode has only an azimuthal magnetic field component and has no vertical magnetic field component. This means that the magnetic field response can be restored in any point P at the receiver location if the declination D and the inclination I at this point are known. See FIG. 1.

The declination D and the inclination I can be calculated with accuracy sufficient for EM sounding for any point on the surface of the earth or inside it, for any date, using the International Geomagnetic Reference Field model (IGRF-10 for example).

The most efficient setup is when the measurement points Pₑ are located in the equatorial plane (the equatorial plane is the plane that coincides with the vertical transmitter line and is orthogonal to the local magnetic meridian—LMM). Such a setup is called an “equatorial setup”. In this case the signal is maximal and directed along LMM.

In Pₘ points located in the horizontal plane and lying on LMM, the azimuth magnetic field generated by the vertical current L_{z} is equal to zero, and measurements in Pₘ points give the total field of variations; this field can be used for evaluating geomagnetic variations and correcting the signals measured in equatorial Pₑ points.

The main features of the invention are as follows:

The present invention provides an assembly for determining the response of the medium by means of total-field magnetometers and/or gradiometers which, in contrast to other CSEM methods, are insensitive to the tilt of the sensor. The present invention provides a method and an apparatus for the EM prospecting of resistive targets embedded below the sea floor in a structure assumed or known to contain a subterranean hydrocarbon reservoir, based on measurements of the galvanic mode of the field by means of total-field magnetometers and total-field gradiometers.

The present invention also provides a method of constructing a comprehensive image of resistivity ρ(x, y, h) of reservoir geometry in the horizontal and vertical directions on the basis of transformations and 1D inversion of responses determined by measurements of the galvanic mode of the magnetic field measured with total-field magnetometers and total-field gradiometers.

In a first embodiment, at least one receiver containing a total-field magnetometer placed in the equatorial point Pₑ on the sea floor makes measurements of the magnetic field excited in the medium by a vertical transmitter current. The transmitter can operate in the frequency domain or the time domain.

In a second embodiment, a transmitter fixed somewhere within the area thought or known to contain a subterranean hydrocarbon reservoir injects a current into a vertical cable embedded in sea water. The transmitter can operate in the frequency domain or the time domain. A plurality of receivers fixed on the sea floor, according to a specific scheme, in equatorial Pₑ and meridional Pₘ points strictly synchronously make measurements of the modulus of the total magnetic field excited in the medium by a vertical transmitter current. Meridional points are used as reference points for the suppression of natural geomagnetic noise.

In a third embodiment, the measurements of the modulus of the magnetic field made with the total-field magnetometers or the total-field gradiometers are used for the determination of the response of a structure and subsequently its transformation, inversion and 3D imaging of the hydrocarbon reservoir. The measurements of the modulus are carried out in the near zone (0≦R<<(2πtρₐ/μ₀)^{1/2}, in which t is the time elapsed after switching off the nearest pulse of the transmitter current; μ₀=4π10⁻⁷ H/m; and ρₐ is the apparent resistivity of the substratum within the intervals between pulses, when the transmitter current is switched off.

In a first aspect, the invention relates more specifically to a system for the electromagnetic surveying of a hydrocarbon reservoir below a sea floor, characterized by the system including a plurality of receivers distributed on the sea floor, each receiver being provided with a recorder device comprising a total-field magnetometer which is arranged to determine a medium response to an electromagnetic field provided in the medium by an electrical current in a vertical transmitter cable submerged in a water mass; a controlled-source electromagnetic transmitter provided with a vertical transmitter cable arranged to be submerged in the water mass and arranged to provide an alternating magnetic field; and signal-processing means which are arranged to receive and process a signal from each of the receivers, the signal characterizing, at least in part, the apparent resistivity and total resistance of the reservoir.

The system may include one or more of the following alternative embodiments:
Each receiver may comprise a resistivity meter which is arranged to work synchronously with the total-field magnetometer and the transmitter.
Each total-field magnetometer may be provided with a clocking device which may be housed within a magnetometer housing, and which is arranged to provide an accurate timing signal for the synchronization of all the receivers, gradient measurements and for use in signal processing and stacking.
The clocking device may be any device capable of generating an accurate timing signal.
The clocking device may be a crystal oscillator.
The transmitter may include a vertical electrical cable installed on a vessel and is arranged, together with the receivers, to be moved from one place to another above the structure which is thought or known to contain the subterranean hydrocarbon reservoir.
All the receivers may be placed equidistantly from and around the transmitter cable.
All the receivers may be placed on the sea floor along a line passing through the vertical transmitter cable in the direction of the local magnetic meridian; that is to say, in a meridional setup.
All the receivers may be placed on the sea floor along a line passing through the vertical transmitter cable perpendicularly to the direction of the local magnetic meridian; that is to say, in an equatorial setup.
All the receivers may be arranged to work synchronously with the transmitter.
All the magnetometers may be arranged to measure the total magnetic field and some pairs of the magnetometers are arranged to measure the difference in the total magnetic field; that is to say, function as gradiometers, one magnetometer of each pair belonging to an equatorial setup and another one to a meridional setup.
The transmitter may be arranged to emit an electromagnetic field at a selected frequency arranged to provide reliable measurements of the strength of the magnetic field with accuracy sufficient for distinguishing signal responses when the structure does contain a reservoir and when the structure does not contain a reservoir.
A horizontal distance (offset) between the transmitter cable and any one of the receivers may have been selected in combination with the electromagnetic field frequency, the intensity of the transmitting energy and the expected electrical properties of the water mass, the structure and the reservoir.
The transmitter may be arranged to emit intermittent current pulses having sharp termination, and recorder devices on the sea floor are arranged to produce measurements of the medium responses during a time lapse between two consecutive current pulses.
The horizontal distance (offset) between the transmitter cable and any one of the receivers, the duration of current pulses and the time lapses between the current pulses may be selected in combination with the intensity of the transmitting energy and the expected electrical properties of the water mass, the structure and the reservoir of the section being surveyed, to
   a) satisfy the validity of the near zone condition R<<\sqrt{tρₐ(t)/μ₀}, in which R is the distance (offset), t is the time lapse delay counted from the moment after switching off the transmitter, μ₀=4π·10⁻⁷ H/m; and ρₐ(t) is the apparent resistivity of the substratum for the time lapse t, and
   b) provide the reliable measurements of the difference in magnetic field strength in the case when the reservoir does exist as compared to the case when a reservoir is absent.
The preferred duration of the electric pulses may fall within the range of 0.1 s to 30 s.
The preferred horizontal distance (offset) between the transmitter antenna and any one of the receivers may be in the range of 100-2000 metres.
The system may further include at least one sensor which is arranged to make measurements of the specific resistivity of the sea water.
The transmitter may include one or more vertical cables arranged in the near zone and in the immediate vicinity of each other or at some distance from each other.

In a second aspect, the invention relates more specifically to a method of marine offshore hydrocarbon electromagnetic prospecting, characterized by including the steps of:
a) deploying a vertical, elongated electric transmitter cable, which is attached to a transmitter, in a water mass above a structure thought or known to contain a subterranean hydrocarbon reservoir;
b) distributing a plurality of receivers, each including a magnetometer which is arranged to provide a signal in response to the electromagnetic field induced by the transmitter, on a sea floor at a distance from and around the transmitter;
c) obtaining from each receiver the total magnetic field responses of electromagnetic fields excited by the transmitter;
d) accumulating, processing and storing response functions relating to signals from the transmitter and characteristic electrical properties of the structure; and
e) analysing the measurement data with the objective of searching for and identifying a hydrocarbon reservoir.

The method may include one or more of the following alternative embodiments:
Each receiver may comprise a resistivity meter.
Each receiver may include a clocking device providing an accurate timing signal for the synchronization of total magnetic field and gradient measurements and data processing.
The vertical transmitter cable can emit energy at a frequency selected to provide electromagnetic field strength sufficient for distinguishing signal responses when the structure does contain a reservoir and when the structure does not contain a reservoir.
The frequency may fall within a range of 0.01 Hz to 30 Hz.
The distance between the vertical transmitter cable and any one of the receivers on the sea floor may have been selected in combination with the frequency, the intensity of the transmitting energy and the expected electrical properties of the water mass, the structure and the reservoir.
The transmitter may emit intermittent current pulses of sharp termination, and recorder devices on the sea floor produce measurements of the medium responses during the time lapses between consecutive pulses.
The distance (offset) between the transmitter cable and any one of the receivers on the sea floor, the duration of the current pulses and the time lapses may be selected in combination with the intensity of the transmitting energy and the expected electrical properties of the water mass, the structure and the reservoir to
   a) satisfy the validity of the near zone condition R<<\sqrt{tρₐ(t)/μ₀}, in which R is the distance (offset), t is the time lapse delay counted from the moment after switching off the transmitter, μ₀=4π·10⁻⁷ H/m, ρₐ(t) is the apparent resistivity of the substratum for the time lapse t, and
   b) provide the reliable measurements of the difference in the magnetic field strength in the case when the reservoir does exist as compared to the case when a reservoir is absent.
The preferred duration of the electrical current pulses may fall within the range of 0.1 s to 30 s.
The distance (offset) between the transmitter cable and any one of the receivers on the sea floor may be in the range of 100-2000 metres.
All the magnetometers on the sea floor may be placed around the transmitter cable.
All the magnetometers may be placed on the sea floor along a line passing through the vertical transmitter cable in the direction of the local magnetic meridian; that is to say, in a meridional setup.
All the magnetometers may be placed on the sea floor along a line passing through the vertical transmitter cable perpendicularly to the direction of the local magnetic meridian; that is to say, in an equatorial setup.
All the magnetometers on the sea floor may work synchronously with the transmitter.
A data-logging process may provide a total magnetic field difference between the measurements of some pairs of magnetometers; in each pair, one magnetometer belongs to the equatorial setup and another one to the meridional setup.
The data-logging process may include the accumulation of all the differences.
The data-logging process may include the accumulation of all the total field measurements.
The data-logging process may further include sea-water resistivity measurements.
Responses for the total magnetic field and its difference may be used to profile and map anomalies characterizing the reservoir location and geometry.
The responses for the total magnetic field and its difference can be transformed into apparent-resistivity curves using asymptotical or full numerically calculated response for a normal base cross-section model with the real parameters of system configuration.
The total magnetic field, the difference responses and the apparent-resistivity curves can be used to image 1D, 2D and 3D models of the reservoir and the research area.

The understanding of the present invention will be facilitated when the following detailed description of a preferred embodiment of the present invention is considered together with the accompanying drawings, in which like reference symbols refer to like parts, and in which:

FIG. 1 shows magnetic field components X, Y, Z and the total magnetic field vector T. P is a point on the surface of the earth, D is the declination, I is the inclination.

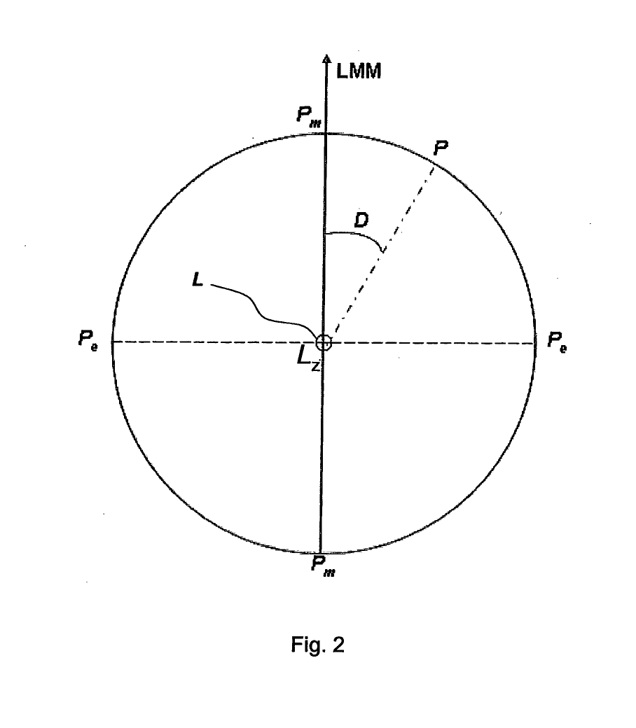

FIG. 2 shows the scheme of sensor installation according to the present invention. L_{z} is the location of a vertical transmitter cable which is L metres long. LMM is the direction of the local magnetic meridian; Pₑ and Pₘ are receivers placed in the equatorial plane and the meridional plane respectively.

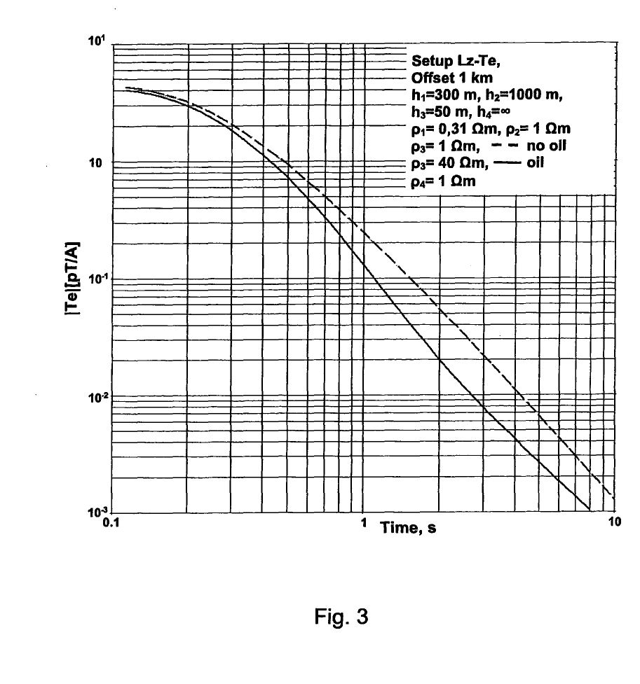

FIG. 3 shows, normalized on the current, the response function /Te/ versus time for a 1D four-layer structure excited by series of step-type current pulses transmitted through a vertical transmitter cable, 300 m long. Parameters of the cross section: h₁=300 m (sea water), h₂=1000 m (sediments), h₃=50 m (reservoir), h₄=∞, ρ₁=0.31Ωm, ρ₂=1Ωm, ρ₃=1Ωm (solid line—oil) or 40Ωm (dashed line—no oil), ρ₄=1Ωm. The offset (distance between the transmitter and the receiver) equals 1000 metres.

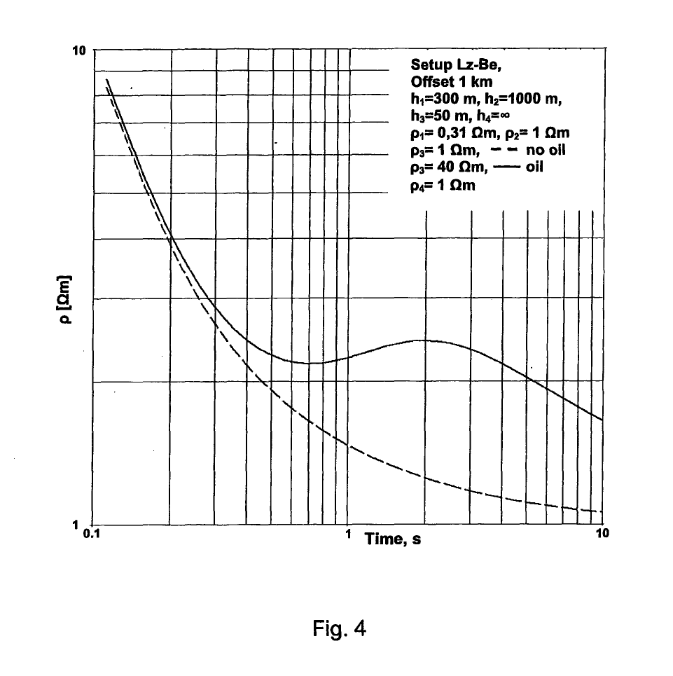

FIG. 4 shows an apparent-resistivity curve p corresponding to the response presented in FIG. 3.

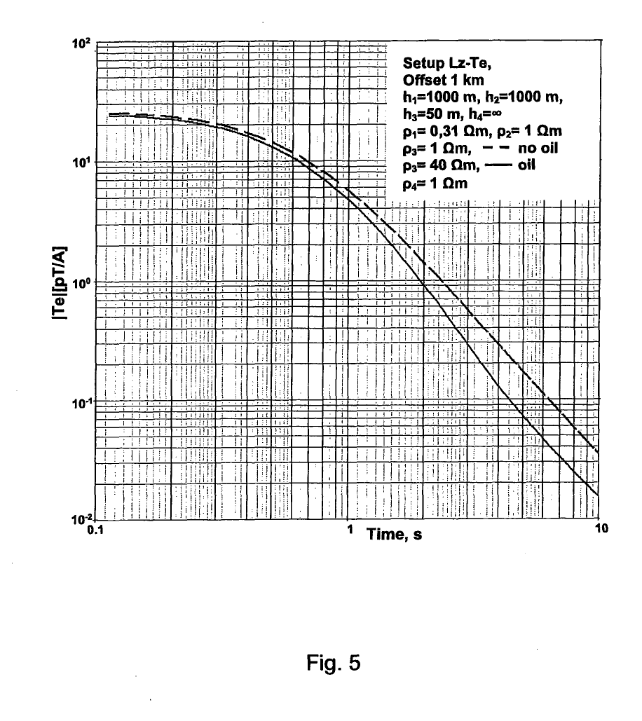

FIG. 5 shows, normalized on the current, the response function /Te/ versus time for a 1D four-layer structure excited by series of step-type current pulses transmitted through a vertical transmitter cable, 1000 m long. Parameters of the cross section: h₁=1000 m (sea water), h₂=1000 m (sediments), h₃=50 m (reservoir), h₄=∞, ρ₁=0.31Ωm, ρ₂=1Ωm, ρ₃=1Ωm (solid line—oil) or 40Ωm (dashed line—no oil), ρ₄=1Ωm. The offset (distance between the transmitter and the receiver) equals 1000 metres.

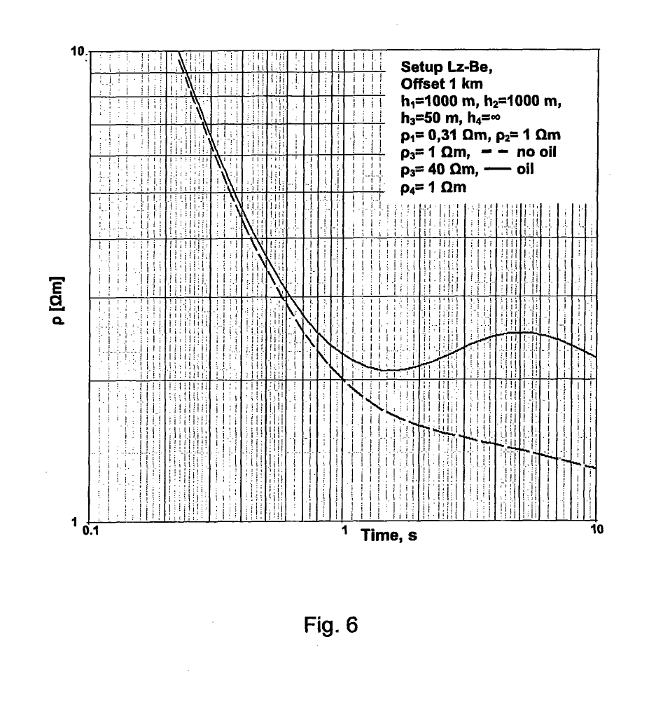

FIG. 6 shows an apparent-resistivity curve p corresponding to the response presented in FIG. 5.

As it is known within the art, hydrocarbon reservoirs have a specific resistivity that is appreciably greater than that of the bearing sediments. Generating the galvanic mode of an electromagnetic field via an electrical current impressed through the vertical cable embedded in sea water is most sensitive to this kind of target. The main problem in applying a system of such a kind is connected to the measurements of electrical response. Electrical measurements are produced by electrodes which are noisy and unstable. In addition, a small inaccuracy in the orientation of the measuring lines can lead to a huge error in the final result; this circumstance increases the cost and reduces the efficiency of surveying. Attempts to replace the measurements of the horizontal and vertical components with three slanted components with subsequent recalculation into horizontal and vertical components only replace the difficulties relating to orientation with difficulties relating to measurement precision for angles and fields.

In the present invention, for measurements of electromagnetic response, it is proposed to use a total-field magnetometer or total-field gradiometer (for example a magnetometer with optical pumping) as it is shown in FIG. 1.

As it is known, measuring results produced by magnetometers of this kind depend very weakly on the orientation of the sensors. The direction of the total-field vector can be calculated by the use of existing models of the main geomagnetic field and its secular variations, for example the IGRF model constructed on the basis of satellite and observatory measurements (Langel, 1987).

FIG. 2 illustrates a first exemplary embodiment of a system according to the present invention. The system consists of a transmitter installed on a vessel (not shown) and several total-field magnetometers P placed on the sea floor in a location L_{z}. The transmitter generates and injects an alternating current of the harmonic-wave or step-type form into a vertical subsea transmitter cable. A plurality of magnetometers Pₑ and Pₘ, respectively, placed in the equatorial plane and the meridional plane measure response signals excited in the medium by the current on the vertical transmitter cable.

As the magnetometers P measure the modulus of the total field, the amplitude of the response signal depends on the magnetometer location: it is maximal on the geomagnetic equator (geomagnetic latitude φ is equal to 0°) and minimal on the geomagnetic pole (geomagnetic latitude φ is equal to 90°). This means that the proposed method of hydrocarbon prospecting is valid everywhere, apart from in a small area around the geomagnetic poles (north and south).

It is important to note that in a laterally layered structure, a vertical current excites only the galvanic mode which does not contain the vertical magnetic field. So, the magnetometers measure only the projection of the horizontal magnetic field response onto the direction of the total magnetic field—FIG. 1. This field coincides with the horizontal component of the geomagnetic equator and changes proportionally to cosine of the geomagnetic inclination I—(1).

Thus, one or a plurality of magnetometers Pₑ placed in the equatorial plane measure(s) the response signal which has information on hydrocarbon targets, whereas one or a plurality of magnetometers Pₘ placed in the meridional plane measure(s) only electromagnetic fields containing geomagnetic variations, and other noise which can be used as a reference signal for noise removal.

The measurements of the total field response /T/=/Tₑ−Tₘ/ according to the differential (gradient) manner provide a response signal which is clean from electromagnetic noise.

Even though both forms of an electromagnetic exciting current (harmonic and pulsed) are suitable for EM prospecting, the pulse-pause current system (transient) is preferred because the measurements during the pauses provide maximal independence of the transient signal from the primary field and maximal resolution with respect to the target. In the present invention the transient system is considered to be the preferred setup. Similarly to TEMP-OEL, this system can be named TEMP-TF (Transient Electromagnetic Marine Prospecting-Total Field).

The difference from TEMP-OEL consists in the use of a total-field magnetometer or gradiometer, placed in a particular way, providing measurements of the horizontal field projected on the direction of the main geomagnetic field vector.

As it was said above, EM sounding may be fulfilled by a system consisting of one vertical transmitter cable and at least one total-field magnetometer; however, the preferred embodiment has a plurality of magnetometers: several placed in the equatorial plane and others in the meridional plane. Other preferred embodiments operate with multiple gradiometers having remote sensors placed in the equatorial and meridional planes. Such a setup makes it possible to clean the response measurements from EM noise and increase the signal/noise ratio.

On the vertical transmitter cable L_{z} (see FIG. 2), the transmitter transmits special series of current pulses of the pulse-pause type which are used, after noise removal and stacking, for analysis and inversion. The typical response functions /Tₑ(t)/ [pT/A] are presented in FIGS. 3 and 5. These functions are calculated for the case when the survey is located on the geomagnetic equator (South America, Africa, India, Indo-China, et cetera), where the inclination I is close to 0°. The form of these responses does not depend on the area's location; the amplitude changes proportionally to the cos(I) of a surveying area's location.

Apparent-resistivity curves ρ(t) corresponding to the models used for the calculation of responses demonstrated in FIGS. 3 and 5 are shown in FIGS. 4 and 6. In the present invention, the late-stage asymptote is proposed for the calculation of ρ(t).

$$ρ ( t ) = {[ \frac{{P}_{2} {σ}_{1}}{40 π \sqrt{π}} \frac{{rh}_{0}^{2} {μ}_{0}^{7 / 2}}{{t}^{5 / 2}} \frac{1}{\vert {T}_{e} ( t ) \vert cos ( I )} ]}^{2 / 3} \qquad ( 2 )$$

Here, t is the time delay of the transient, P_{z} is the electric moment of the transmitter line (P_{z}=I*L_{z}, I is the intensity of the current; L_{z} is the length of the vertical transmitter cable), σ₁ is the specific conductivity of sea water, h is the sea depth, r is the offset, μ₀ is the magnetic permeability of vacuum, Tₑ(t) is the total magnetic field response at the delay t, cos(I) is the cosine of the local geomagnetic inclination I.

FIGS. 3-6 demonstrate that the field responses as well as the apparent-resistivity curves have high resolution with respect to hydrocarbon targets for both deep and shallow water. Maximal resolution exists in the time range 2-3 s for shallow water and 4-6 s for deep water. The signal achieves hundreds and thousands of pico-teslas (pT) at a transmitting current of 1 kA; such a total magnetic field value is quite measurable by modern magnetometers.

The specific conductivity σ₁ of the sea water can either be measured by means of a resistivity meter or be calculated from the water temperature, salinity and pressure at any depth.

The calculation of apparent resistivity on the basis of the full transient process in a layered structure is proposed as the preferred embodiment for data presentation. This calculation is produced numerically. Such a presentation has an advantage over the asymptotic presentation because it improves the resolution with respect to the section in an early stage of the transient process.

### REFERENCES

### US Patent Documents

| Publication No. | Published | Applicant/inventor |
|---|---|---|
| 4,617,518 | October 1986 | Srnka |
| 5,563,513 | October 1996 | Tasci |
| 0,052,685 A1 | March 2003 | Ellingsrud et al. |
| 0,048,105 A1 | March 2003 | Ellingsrud et al. |
| 6,628,119 B1 | October 2003 | Eidesmo et al. |
| 6,842,006 | January 2005 | Conti et al. |
| 0,309,346 A1 | December 2008 | MacGregor et al. |
| 0,265,896 A1 | October 2008 | Strack et al. |
| 0,309,346 A1 | December 2008 | MacGregor et al. |
| 0,265,896 A1 | October 2008 | Strack et al. |

### Other Patent Documents

| Publication No. | Published | Applicant/inventor |
|---|---|---|
| WO 01/57555 A1 | September 2001 | Ellingsrud et al. |
| WO 02/14906 A1 | February 2002 | Ellingsrud et al. |
| WO 03/025803 A1 | March 2003 | Srnka et al. |
| WO 03/034096 A1 | April 2003 | Sinha et al. |
| WO 03/048812 A1 | June 2003 | MacGregor et al. |
| WO 053025 A1 | May 2007 | Barsukov et al. |

### Norwegian Patent Documents

| Publication No. | Published | Applicant/inventor |
|---|---|---|
| NO 323889 B1 G01V | 3/12 01/2006 | Barsukov et al. |

### OTHER PUBLICATIONS

Amundsen H. E. F., Johansen S. Røsten T.; 2004: A Sea Bed Logging (SBL) calibration survey over the Troll Gas Field. 66^{th} EAGE Conference & Exhibition, Paris, France, 6-10 Jun. 2004.
Chave A. D. and Cox C. S.; 1982: Controlled Electromagnetic Sources for Measuring Electrical conductivity Beneath the Oceans 1. Forward Problem and Model Study. Journal of geophysical Research, 87, B7, pp. 5327-5338.
Chave A. D., Constable S. C., Edwards R. N.; 1991: Electrical Exploration Methods for the Seafloor. Chapter 12. Ed. by Nabighian, Applied Geophysics, v.2, Soc. Explor. Geophysics, Tulsa, Okla. pp. 931-966.
Cheesman S. J., Edwards R. N., Chave A. D.; 1987: On the theory of sea floor conductivity mapping using transient electromagnetic systems. Geophysics, V. 52, N2, pp. 204-217.
Constable S. C., Orange A. S., Hoversten G. M., Morrison H. F.; 1998: Marine magnetotellurics for petroleum exploration. Part 1: A sea floor equipment system. Geophysics, V. 63, N3, pp. 816-825.
Coggon J. H., Morrison. H. F.; 1970: Electromagnetic investigation of the sea floor: Geophysics, V. 35, pp. 476-489.
Edwards R. N., Law, L. K., Delaurier, J. M.; 1981: On measuring the electrical conductivity of the oceanic crust by a modified magnetometric resistivity method: J. Geophys. Res., V. 68, pp. 11609-11615.
Edwards R. N., Law L. K., Wolfgram P. A., Nobes D. C., Bone M. N., Trigg D. F., DeLaurier J. M.; 1985: First results of the MOSES experiment: Sea sediment conductivity and thickness determination. Bute Inlet, British Columbia, by magnetometric off-shore electrical sounding. Geophysics, V. 450, N1, pp. 153-160.
Edwards R. N. and Chave A. D.; 1986: On the theory of a transient electric dipole-dipole method for mapping the conductivity of the sea floor. Geophysics, V. 51, pp. 984-987.
Edwards R.; 1997: On the resource evaluation of marine gas hydrate deposits using sea-floor transient dipole-dipole method. Geophysics, V. 62, N1, pp. 63-74.
Eidesmo T., Ellingsrud S., MacGregor L. M., Constable S., Sinha M. C., Johansen S. E., Kong N. and Westerdahl, H.; 2002: Sea Bed Logging (SBL), a new method for remote and direct identification of hydrocarbon filled layers in deepwater areas. First Break, 20, March, pp. 144-152.
Ellingsrud S., Sinha M. C., Constable S., MacGregor L. M., Eidesmo T. and Johansen S. E.; 2002: Remote sensing of hydrocarbon layers by Sea Bed Logging (SBL): results from a cruise offshore Angola. The Leading Edge, 21, pp. 972-982.
Haber E., Ascher U. and Oldenburg D. W.; 2002: Inversion of 3D time domain electromagnetic data using an all-at-once approach: submitted for presentation at the 72^{nd} Ann. Internat. Mtg: Soc. of Expl. Geophys.
Howards R. N., Law L. K., Delaurier J. M.; 1981: On measuring the electrical conductivity of the oceanic crust by a modified magnetometric resistivity method: J. Geophys. Res., 86, pp. 11609-11615.
Johansen S. E., Amundsen H. E. F., Røsten T., Ellinsgrud S., Eidesmo T., Bhuyian A. H.; 2005: Subsurface hydrocarbon detected by electromagnetic sounding. First Break, V. 23, pp. 31-36.
Langel R. A., 1987: Main Field, in Geomagnetism, edited by J. A. Jacobs, Academic Press, San Diego, Calif., 249 pp.
MacGregor L., Tompkins M., Weaver R., Barker N.; 2004: Marine active source EM sounding for hydrocarbon detection. 66^{th} EAGE Conference & Exhibition, Paris, France, 6-10 Jun. 2004.
Wright D. A., Ziolkowski A., and Hobbs B. A.; 2001: Hydrocarbon detection with a multichannel transient electromagnetic survey. 70^{th} Ann. Internat. Mtg., Soc. of Expl. Geophys.
Yuan J., Edward R. N.; 2004: The assessment of marine gas hydrates through electrical remote sounding: Hydrate without BSR? Geophys. Res. Lett., V. 27, N16, pp. 2397-2400.
Ziolkovsky A., Hobbs B., Wright D.; 2002: First direct hydrocarbon detection and reservoir monitoring using transient electromagnetics. First Break, V. 20, No. 4, pp. 224-225.

1. A system for the electromagnetic surveying of a hydrocarbon reservoir below a sea floor, the system includes
a plurality of receivers (P) distributed on the sea floor, each receiver (P) being provided with a recorder device including a total-field magnetometer which is arranged to determine a medium's response to an electromagnetic field provided in the medium by an electrical current on a vertical transmitter cable (L) submerged in a mass of water;
a controlled-source electromagnetic transmitter attached to the vertical transmitter cable (L) arranged to be submerged in the mass of water and arranged to provide an alternating magnetic field; and
signal-processing means which are arranged to receive and process a signal from each of the receivers (P), the signal characterizing, at least in part, the apparent resistivity and the total resistance of the reservoir.

2. The system according to claim 1 wherein each receiver (P) comprises a resistivity meter which is arranged to work synchronously with the total-field magnetometer and the transmitter.

3. The system according to claim 1 wherein each total-field magnetometer (P) is provided with a clocking device, which may be housed in a magnetometer housing, and is arranged to provide an accurate timing signal for the synchronization of all the receivers (P), the gradient measurements and for use in signal processing and stacking.

4. The system according to claim 3 wherein the clocking device is any device which is capable of generating an accurate timing signal.

5. The system according claim 3 wherein the clocking device is a crystal oscillator.

6. The system according to claim 1 wherein the transmitter includes a vertical electrical cable (L) installed on a vessel and is arranged, together with the receivers (P), to be moved from one location to another above the structure which is thought or known to contain the subterranean hydrocarbon reservoir.

7. The system according to claim 1 wherein all the receivers (P) are placed equidistantly from and around the transmitter cable (L).

8. The system according to claim 1 wherein all the receivers (Pₘ) are placed on the sea floor along a line passing through the vertical transmitter cable in the direction of the local magnetic meridian; that is to say, in a meridional setup.

9. The system according to claim 1 wherein all the receivers (Pₑ) are placed on the sea floor along a line passing through the vertical transmitter cable perpendicularly to the direction of the local magnetic meridian; that is to say, in an equatorial setup.

10. The system according to claim 1 wherein all the receivers (P) are arranged to work synchronously with the transmitter.

11. The system according claim 1 wherein all the receivers (P) are arranged to measure the total magnetic field, and some pairs of the receivers (P) are arranged to measure the difference in the total magnetic field; that is to say, function as gradiometers, one receiver (Pₑ) of each pair belonging to an equatorial setup and another (Pₘ) to a meridional setup.

12. The system according to claim 1 wherein the transmitter is arranged to emit an electromagnetic field at a selected frequency which is arranged to provide reliable measurements of the strength of the magnetic field with accuracy sufficient for distinguishing signal responses when the structure does contain a reservoir and when the structure does not contain a reservoir.

13. The system according to claim 1 wherein a horizontal distance (offset) between the transmitter cable (L) and any one of the receivers (P) is selected in combination with the electromagnetic field frequency, the intensity of the transmitting energy and the expected electrical properties of the water mass, the structure and the reservoir.

14. The system according to claim 1 wherein the transmitter is arranged to transmit intermittent current pulses having sharp termination, and the receivers (P) on the sea floor are arranged to produce measurements of the medium responses during a time lapse between two consecutive current pulses.

15. The system according to claim 1 wherein the horizontal distance (offset) between the transmitter cable (L) and any one of the receivers (P), the duration of the current pulses and the time lapses between the current pulses are selected in combination with the intensity of the transmitting energy and the expected electrical properties of the water mass, the structure and the reservoir in the section being surveyed, to
a) satisfy the validity of the near zone condition R<<\sqrt{tρₐ(t)/μ₀} in which R is the distance (offset), t is the time lapse counted from the moment after switching off the transmitter, μ₀=4π·10⁻⁷ H/m; and ρₐ(t) is the apparent resistivity of the substratum for the time lapse t, and
b) provide the reliable measurements of the difference in magnetic field strength in the case when the reservoir does exist as compared to the case when a reservoir is absent.

16. The system according to claim 1 wherein the smallest horizontal distance (offset) r between the transmitter cable (L) and any one of the receivers (P) on the sea floor fulfils the condition 0<r<R, in which r is the distance at which the induced polarization (IP) effect is small enough to be ignored, preferably within the range of 100-2000 metres.

17. A method of marine sub-sea-floor hydrocarbon electromagnetic prospecting, the method comprising the steps:
a) placing a plurality of receivers (P) spaced apart on a sea floor, each receiver (P) being provided with a recorder device including a total-field magnetometer which is arranged to determine a medium response to an electromagnetic field provided in the medium by an electrical current in a vertical transmitter cable (L) submerged in a mass of water;
b) placing a controlled-source electromagnetic transmitter attached to the vertical transmitter cable (L) submerged in the mass over water above a structure which is thought or known to contain a subterranean hydrocarbon reservoir, in such a way that all the magnetometers (Pₘ and Pₑ, respectively) are placed on the sea floor, either along a line passing through the vertical transmitter cable (L) in the direction of the local magnetic meridian; that is to say, in a meridional setup; or along a line passing through the vertical transmitter cable (L) perpendicularly to the direction of the local magnetic meridian; that is to say, in an equatorial setup;
c) obtaining from each receiver (P, Pₘ, Pₑ) the total magnetic field responses of electromagnetic fields excited by the transmitter;
d) accumulating, processing and storing response functions relating to signals from the transmitter and characteristic electrical properties of the structure; and
e) analysing the measurement data with the objective of searching for and identifying hydrocarbon reservoirs.

18. The method according to claim 17 wherein a data-logging process provides a difference in total magnetic field between measurements of some pairs of magnetometers (P), one magnetometer (Pₘ and Pₑ, respectively) of each pair belonging to the equatorial setup and another to the meridional setup.

19. The method according to claim 17 wherein the data-logging process includes the accumulation of all the differences as well as total magnetic field measurements and is used to analyse the measured data with the object of searching for and identifying hydrocarbon reservoirs.

20. The method according to claim 17 wherein each receiver (P) includes a resistivity meter and a clocking device which provides an accurate timing signal for total magnetic field and gradient measurement synchronization and data processing.

21. The method according to claim 17 wherein the vertical transmitter cable (L) emits energy at a frequency selected to produce electromagnetic field strength sufficient for distinguishing between signal responses when the structure does contain a reservoir and when the structure does not contain a reservoir.

22. The method according to claim 17 wherein the distance (offset) between the vertical transmitter cable (L) and any one of the total-field magnetometers (P) on the sea floor is selected in combination with the frequency, the intensity of the transmitting energy and the expected electrical properties of the water mass, the structure and the reservoir.

23. The method according to claim 17 wherein the transmitter emits intermittent current pulses having sharp termination, and the receivers (P) on the sea floor produce measurements of the medium responses during the time lapses between consecutive pulses.

24. The method according to claim 17 wherein the distance (offset) between the transmitter cable (L) and any one of the total-field magnetometers (P) on the sea floor, the duration of the current pulses and the pauses are selected in combination with the intensity of the transmitting energy and the expected electrical properties of the water mass, the structure and the reservoir, to
a) satisfy the validity of the near zone condition R<<\sqrt{tρₐ(t)/μ₀}, in which R is the distance (offset), t is the time lapse delay counted from the moment after switching off the transmitter, μ₀=4π·10⁻⁷ H/m; and ρₐ(t) is the apparent resistivity of the substratum for the time lapse t, and
b) provide reliable measurements of the difference in magnetic field strength in the case when the reservoir does exist as compared to the case when the reservoir is absent.

25. The method according to claim 17 wherein the smallest distance (offset) r between the transmitter cable (L) and any one of the total-field magnetometers (P) on the sea floor fulfils the conditions 0<r<R, in which r is the distance at which the induced polarization (IP) effect is small enough to be ignored, preferably in the range of 100-2000 metres.

26. The method according to claim 17 wherein the responses for the total magnetic field and its differences are transformed into apparent-resistivity curves by the use of asymptotical or full numerically calculated response for a normal base cross-section model with the real parameters of system configuration in order then to be used in profiling an mapping of anomalies characterizing the reservoir location and reservoir geometry.

27. The method according to claim 17 wherein the total magnetic field, the difference responses and the apparent-resistivity curves are used for imaging 1D, 2D and 3D models of the reservoir and the research area.
